(19) United States
(12) Patent Application Publication
(10) Pub. No.: US 2026/0332017 A1
(43) Pub. Date: Oct. 22, 2026

(54) A MOTOR BASE AND A MANUFACTURING METHOD THEREOF

(71) Applicant: SUZHOU GYZ ELECTRONIC TECHNOLOGY CO., LTD., Suzhou (CN)

(72) Inventor: Guowei XU, Suzhou (CN)

(21) Appl. No.: 19/107,550

(22) PCT Filed: May 9, 2023
(86) PCT No.: PCT/CN2023/093042

§ 371 Date: Feb. 27, 2025

(30) Foreign Application Priority Data
Sep. 27, 2022 (CN) 202211194817.8

(51) Int. Cl. H02K 41/035; H02K 5/08; H02K 11/33; H02K 15/123; H02K 15/32

(52) U.S. Cl. CPC H02K 41/0354; H02K 5/08; H02K 11/33; H02K 15/123; H02K 15/32

(57) ABSTRACT

The present invention relates to a motor base and a manufacturing method therefor. The motor base includes an insulating base, a metal circuit arranged at the insulating base and an electronic element welded to the metal circuit. The metal circuit comprises a plurality of conductive terminals including a first conductive terminal, a second conductive terminal and a third conductive terminal arranged between the first conductive terminal and the second conductive terminal. Each conductive terminal comprises a weld leg for welding with the electronic element and a connecting section extending from the weld leg. A bridging part of the first conductive terminal spans the third conductive terminal from a corresponding connecting section, such that the second lap joint part of the second conductive terminal overlaps with and is fixedly connected to a first lap joint part of the second conductive terminal.

### TECHNICAL FIELD

The present invention relates to the field of camera module technology, specifically relates to a motor base for electronic equipment and a manufacturing method thereof.

### BACKGROUND

Existing motors and their motor bases usually include an insulating base, a metal circuit molded in the insulating base, electronic element welded to the metal circuit, a coil formed by winding or assembled by mounting, and a magnetic structure that interacts with the coil. The metal circuit includes multiple conductive terminals, usually one end of the conductive terminal is used as a weld leg to connect the electronic element, and the other end of the conductive terminal is used as a pin end to extend out of the motor base and connect to external components. If there are more electronic elements, the number of conductive terminals required is correspondingly large, and more conductive terminals cannot be arranged in a limited space.

In order to overcome the above problems, different electronic elements can be connected to the same conductive terminal, and the same pin end is extended out of the motor base to connect to external components, that is, two spaced conductive terminals need to be connected so that different electronic elements are connected to the same conductive terminal. However, since electronic elements need to be set in different positions according to functional requirements and are relatively dispersed, in order to be able to simultaneously connect different electronic elements at different positions, the conductive terminal needs to be bent many times to connect different electronic elements, not only is the path of the conductive terminal long, but too many bending times of the conductive terminal will result in the inability to form a shape, or even if it can be formed, it cannot be avoided that it is easy to be bent and broken during the manufacturing process, resulting in a decrease in product manufacturing yield.

Therefore, it is necessary to provide a new motor base and a manufacturing method thereof to overcome the above-mentioned defects.

### SUMMARY OF THE INVENTION

The purpose of the present invention is to provide a motor base and a manufacturing method thereof, which can avoid the conductive terminal from being bent too many times and unable to be formed, and save the wiring space of the conductive terminal.

The purpose of the present invention is achieved by the following technical solution 1: a motor base, comprising: an insulating base, a metal circuit disposed on the insulating base, and an electronic element welded to the metal circuit, wherein the metal circuit includes a plurality of conductive terminals including a first conductive terminal, a second conductive terminal, and a third conductive terminal arranged between the first conductive terminal and the second conductive terminal, each conductive terminal comprises a weld leg for welding with the electronic element and a connecting section extending from the weld leg, and the first conductive terminal includes a bridging part and a first lap joint part extending from the bridging part; the second conductive terminal includes a second lap joint part extending from the corresponding connecting section, the bridging part of the first conductive terminal spans the third conductive terminal from the corresponding connecting section, thereby causing the first lap joint part to overlap and be fixedly connected to the second lap joint part, and the insulating base is formed by injection molding and at least covers and is fixed outside the first conductive terminal and the second conductive terminal.

Optionally, the electronic element includes at least two different electronic elements, and the weld legs of the first conductive terminal and the second conductive terminal are configured to weld the two different electronic elements; only one of the first conductive terminal and the second conductive terminal has a pin end extending out of the insulating base to be electrically connected to an external circuit, such that the first conductive terminal and the second conductive terminal share the same pin end.

Optionally, the insulating base includes a plurality of plastic blocks which are formed by one-shot injection molding and covering the metal circuit, and the weld leg, the first lap joint part, and the second lap joint part are exposed on the same surface of the corresponding plastic blocks, the insulating base further includes a plastic body formed by two-shot injection molding to cover the metal circuit and a plurality of the plastic blocks which are arranged vertically and located on different vertical planes, and the different electronic elements are positioned on the different plastic blocks and exposed on the corresponding plastic blocks.

Optionally, the connecting section of the second conductive terminal extends continuously across at least three planes from the corresponding weld leg, the connecting section spans from the vertical plane where the corresponding weld leg is located to the horizontal plane where the bottom surface of the plastic body is located, and then spans to the vertical plane where the weld leg of the first conductive terminal is located.

Optionally, the overlapping position of the second lap joint part and the first lap joint part is defined as the overlapping region, and the second conductive terminal is fixedly connected to the bridging part by a soldering method, and at least one of the first lap joint part and the second lap joint part has a hole for accommodating tin material in the overlapping region.

Optionally, the first conductive terminal and the second conductive terminal in the overlapping region are surface-coated with gold to form a gold-plated region, the gold-plated region covers the upper surface of the first conductive terminal corresponding to the overlapping region, the lower surface opposite to the upper surface, the inner wall of the hole, and the upper wall of the second conductive terminal relatively close to the lower surface of the first conductive terminal.

Optionally, the first lap joint part has the hole in the overlapping region, and the hole is defined as a holding through-hole, the holding through-hole has an opening end away from the second conductive terminal and a resting end near the second conductive terminal, the size of the opening end is smaller than the size of the resting end, and the tin material is contained within the holding through-hole.

Optionally, the second lap joint part has a bulge projecting into the holding through-hole from the upper wall, and the tin material is contained within the holding through-hole and concentrated around the bulge.

Optionally, the first lap joint part has the hole in the overlapping region, the hole of the first lap joint part is defined as a holding through-hole, the holding through-hole has an opening end away from the second conductive terminal and a resting end near the second conductive terminal, the second lap joint part has the hole in the overlapping region, the hole of the second lap joint part is defined as a receiving hole, wherein the receiving hole of the second lap joint part is communicated with the holding through-hole in the overlapping region, and the tin material is contained in both the holding through-hole and the receiving hole.

Optionally, the size of the opening end is larger than the size of the resting end, and the size of the receiving hole is larger than the size of the resting end.

Optionally, the size of the opening end is larger than the size of the resting end, and the holding through-hole and the receiving hole are staggered and communicate with each other, the size of the receiving hole near the first lap joint part is smaller than the size of the receiving hole farther from the first lap joint part, and the tin material is contained within both the holding through-hole and the receiving hole.

Optionally, the lower surface and the upper wall of the first conductive terminal and the second conductive terminal in the overlapping region have a wave-like concave-convex structure, and the concave-convex structure on the lower surface and the concave-convex structure of the upper wall extend in different directions, the tin material is contained in the hole and the concave-convex structure between the lower surface and the upper wall.

Optionally, the area of the first lap joint part is smaller than the area of the second lap joint part, and the first lap joint part has a ring structure, the ring structure is hollowed out to form the hole, and the hole of the ring structure is defined as the holding through-hole, the inner wall is defined as the first inner wall where the holding through-hole is provided, the outer wall of the ring structure is configured as an outer wall surface, and the tin material is at least contained within the hole along the second lap joint part.

Optionally, the second lap joint part has the hole, the hole is defined as a receiving hole, and the first lap joint part in the overlapping region is punched into the receiving hole of the second lap joint part, the first lap joint part is welded and fixed to the second lap joint part.

Optionally, the overlapping position of the first lap joint part and the second lap joint part is defined as the overlapping region, and the first lap joint part is riveted to the second lap joint part within the overlapping region, the first lap joint part has a protruding portion extending downward, and the second lap joint part has a receiving hole to accommodate the protruding portion in the overlapping region.

Optionally, the overlapping position of the first lap joint part and the second lap joint part is defined as the overlapping region, the first lap joint part is arranged in parallel and overlapped with the second lap joint part within the overlapping region, and the first lap joint part and the second lap joint part are connected and fixed by resistance welding, laser welding or riveting.

Optionally, the overlapping position of the first lap joint part and the second lap joint part is defined as the overlapping region, the first lap joint part encapsulates the second lap joint part in the overlapping region, and the first lap joint part is in contact with and connected to the second lap joint part.

Optionally, the bridging part is integrally bent and extended from the connecting section of the first conductive terminal; or the bridging part is arranged separately from the connecting section, and the connecting section of the first conductive terminal further includes a third lap joint part and the bridging part further includes a fourth lap joint part, the third lap joint part overlaps with the fourth lap joint part and is fixedly connected.

Optionally, the thickness of the bridging part is smaller than the thickness of both the connecting section of the first conductive terminal and the second conductive terminal.

Optionally, the portion of the bridging part not overlapping with the first conductive terminal and the second conductive terminal is at least coated with an insulating layer on the side facing the third conductive terminal, such that the bridging part directly contacts the third conductive terminal.

Optionally, a plastic block is injection-molded outside the metal circuit, and the portion of the bridging part overlapping with the first conductive terminal and the second conductive terminal is exposed on the plastic block, and the portion of the bridging portion that is not overlapped with the first conductive terminal and the second conductive terminal is covered by the plastic block.

The purpose of the present invention is achieved by the following technical solution 2: a manufacturing method of a motor base, comprising the following steps:
Step 1: Providing a metal circuit with a plurality of conductive terminals, the conductive terminal includes a first conductive terminal, a second conductive terminal, and a third conductive terminal arranged between the first conductive terminal and the second conductive terminal, each conductive terminal includes a weld leg and a connecting section extending from the weld leg, the first conductive terminal includes a bridging part connected to the connecting section and a first lap joint part extending from the bridging part, the second conductive terminal includes a second lap joint part extending from the corresponding connecting section, the bridging part spans across the third conductive terminal from the corresponding connecting section, causing the first lap joint part to overlap with the second lap joint part;
Step 2: Defining the overlapping area between the first lap joint part and the second lap joint part as the overlapping region, and fixing the first lap joint part and the second lap joint part within the overlapping region;
Step 3: Positioning the electronic elements on the corresponding weld legs and weld them;
Step 4: Injection molding the insulating base is injection molded on the metal circuit.

Optionally, before Step 2, a pin fixture is used to position the overlapping region of the first conductive terminal and the second conductive terminal, and plastic blocks are one-shot injection molding around the metal circuit, with the weld leg, the first lap joint part, and the second lap joint part exposed on the same surface of the plastic blocks.

Optionally, the fixed connection is achieved by a soldering method, and before Step 2, the first lap joint part and the second lap joint part are welding with tin material in the overlapping region at first, and then passed through a reflow oven for welding to complete the fixed connection.

Optionally, at least one of the first lap joint part and the second lap joint part has a hole in the overlapping region to receive tin material.

Optionally, the bridging part is integrally bent and extended from the connecting section of the first conductive terminal; or the bridging part is separately arranged from the connecting section, the connecting section of the first conductive terminal includes a third lap joint part and the bridging part includes a fourth lap joint part, and in Step 2, the first lap joint part and the fourth lap joint part are simultaneously overlapped and fixedly connected to the corresponding second lap joint part and the corresponding third lap joint part.

Optionally, the first lap joint part and the second lap joint part are overlapped in parallel, and the fixed connection is made by laser welding to connect the first lap joint part and the second lap joint part.

Optionally, the fixed connection is made by riveting, and the first lap joint part has a protruding portion extending downward in the overlapping region, and the second lap joint part has a receiving hole to accommodate the protruding portion.

Optionally, the fixed connection is made by riveting, and the first lap joint part encapsulates the second lap joint part in the overlapping region and is fixedly connected to the second lap joint part.

In the present invention, the bridging part of the first conductive terminal in the motor base spans across the third conductive terminal from the corresponding connecting section so that the first lap joint part and the second lap joint part of the second conductive terminal overlap and are fixedly connected, thereby avoiding the failure of a single conductive terminal to be formed due to excessive bending times, improving the forming yield of the conductive terminal, and saving the wiring space of the conductive terminal.

### BRIEF DESCRIPTION OF THE DRAWINGS

FIG. 1 is a perspective schematic diagram of a motor base in a first embodiment of the present invention.

FIG. 2 is a perspective schematic diagram of FIG. 1 viewed from another direction.

FIG. 3 is a perspective exploded view of a motor base in a first embodiment of the present invention.

FIG. 4 is a further perspective exploded view of FIG. 3.

FIG. 5 is an angle schematic diagram of a first retaining wall of a plastic block in FIG. 3.

FIG. 6 is another angle schematic diagram of a first retaining wall of a plastic block in FIG. 3.

FIG. 7 is a partial enlarged view of FIG. 4.

FIG. 8 is a top view of a metal circuit in FIG. 4.

FIG. 9 is a cross-sectional view along line A-A in FIG. 8.

FIG. 10 is a partial enlarged view of FIG. 9.

FIG. 11 is an enlarged view of a cross-sectional view of an overlapping region in a second embodiment of the present invention.

FIG. 12 is an enlarged view of a cross-sectional view of an overlapping region in a third embodiment of the present invention.

FIG. 13 is an enlarged view of a cross-sectional view of an overlapping region in a fourth embodiment of the present invention.

FIG. 14 is an enlarged view of a cross-sectional view of an overlapping region in a fifth embodiment of the present invention.

FIG. 15 is a perspective schematic diagram of the overlapping region in the sixth embodiment of the present invention.

FIG. 16 is an enlarged view of the cross-sectional view of the overlapping region in the sixth embodiment of the present invention.

FIG. 17 is a perspective schematic diagram of the overlapping region in the seventh embodiment of the present invention.

FIG. 18 is an enlarged view of the cross-sectional view of the overlapping region in the seventh embodiment of the present invention.

FIG. 19 is a top view of the motor base in the eighth embodiment of the present invention.

FIG. 20 is a cross-sectional view along the B-B line in FIG. 19.

FIG. 21 is a partial enlarged view in FIG. 20.

FIG. 22 is a perspective schematic diagram of the overlapping region in the ninth embodiment of the present invention.

FIG. 23 is an enlarged view of the cross-sectional view of the overlapping region in the ninth embodiment of the present invention.

FIG. 24 is a perspective schematic diagram of the overlapping region in the tenth embodiment of the present invention.

FIG. 25 is an enlarged view of the cross-sectional view of the overlapping region in the tenth embodiment of the present invention.

FIG. 26 is a perspective view of the metal circuit in the eleventh embodiment of the present invention.

FIG. 27 is an enlarged view of the overlapping region in FIG. 26.

### MAIN COMPONENT SYMBOLS

Please refer to the following figure numbers for explanation, motor base 100; metal circuit 1; first conductive terminal 11, 11A, 11B, 11C, 11D, 11F, 11G, 11H, 11I, 11J, 11K; first lap joint part 110, 110A, 110B, 110C, 110D, 110F, 110G, 110H, 110I, 110J, 110K; holding through-hole 111, 111B, 111C, 111D, 111H, 1110I; opening end 1111, 1111B, 1111C, 1111D, 1111H; resting end 1112, 1112B, 1112C, 1112D, 1112H; protruding portion 111F; bending part 111G; first inner wall 1113, 1113B, 1113C, 1113D, 1113H, 1111I; outer wall surface 1112I; concave-convex structure 13H; ring structure 111I; upper surface 112, 112B, 112C, 112D, 112H, 112I; lower surface 113, 113B, 113C, 113D, 113H, 113I; main body 111J; first bending stage 112J; second bending stage 113J; second conductive terminal 12, 12A, 12B, 12C, 12D, 12F, 12G, 12H, 12I, 12J, 12K; second lap joint part 120, 120A, 120B, 120C, 120D, 120F, 120G, 120H, 120I, 120J, 120K; upper wall 121, 123B, 121C, 121D, 121H, 121I; receiving hole 122D, 122F, 122G; second inner wall 122B, 1221D; bulge 1211C; groove 121B; third conductive terminal 13,13K; clamping blocks 1101G; gap 1221G; pin end 14; weld leg 15; spanning segment 16; connecting section 17,17K; third lap joint part 171K; bridging part 18,18K; forth lap joint part 181K; electronic element 2; insulating base 3; plastic body 31; plastic block 4; first retaining wall 41; loading slot 410; depression groove 4101; step section 411; second retaining wall 42; third retaining wall 43; coil 5; tin material 6; overlapping region R; concave hole S; first plane P1; second plane P2; third plane P3; forth plane P4.

### DETAILED DESCRIPTION

In the description of the present invention, it should be noted that the terms “upper”, “lower”, “inner”, “outer” and the like indicate positions or positional relationships based on the positions or positional relationships shown in the drawings, which are only for the convenience of describing the present invention and simplifying the description, and do not indicate or imply that the device or component referred to must have a specific position, be constructed and operated in a specific position, and therefore cannot be understood as a limitation of the present invention.

In the description of the present invention, it should be noted that, unless otherwise clearly specified and limited, the term “connection” should be understood in a broad sense, and ordinary technicians in the field can understand the specific meaning of the above terms in the present invention according to the specific circumstances.

The conductive terminal in the motor base 100 of the present invention includes a first conductive terminal and a second conductive terminal which are spaced apart from each other, and a third conductive terminal arranged between the first conductive terminal and the second conductive terminal, after the first conductive terminal is bent across the line and spans across the third conductive terminal and then overlaps with the second conductive terminal, a plastic block 4 is one-shot injection molded to achieve mutual positioning, and is directly fixed and connected by welding or riveting to facilitate the electrical connection of the first conductive terminal and the second conductive terminal. With the technical solution of the present invention, the motor base 100 does not need to bend across the line multiple times by only one conductive terminal to connect different electronic elements 2, but two conductive terminals with relatively short conductive paths are set for connection processing, thereby achieving local fixed connection and electrical connection, in this embodiment, due to the first conductive terminal and the second conductive terminal are fixed and electrically connected to each other, the two can share the pin end 14. Therefore, the technical solution of the present application can avoid the inability to form a conductive terminal due to excessive bending times, and can also enable different electronic elements 2 to be connected to the same pin end, thereby saving the wiring space of the conductive terminal. The overlapping of the two conductive terminals increases the contact area between the two, and the electrical connection performance after the connection processing is better, in addition, at least one of the first conductive terminal and the second conductive terminal is bent in three directions, which increases the strength of the motor base 100.

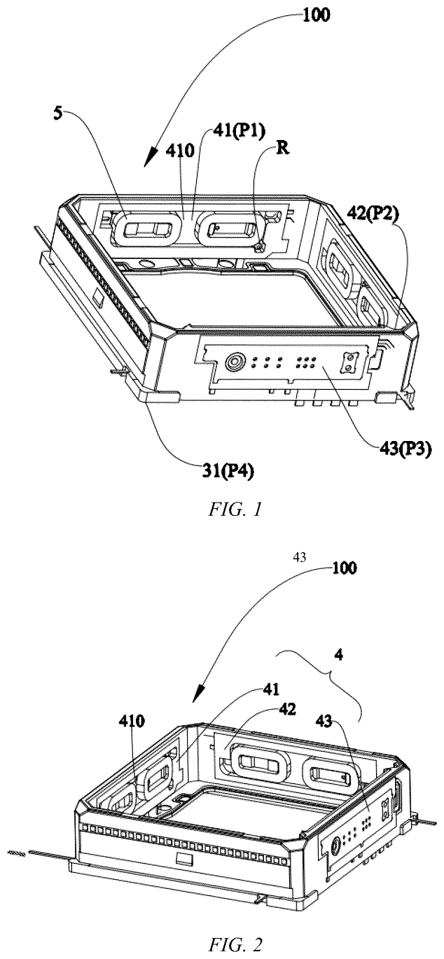

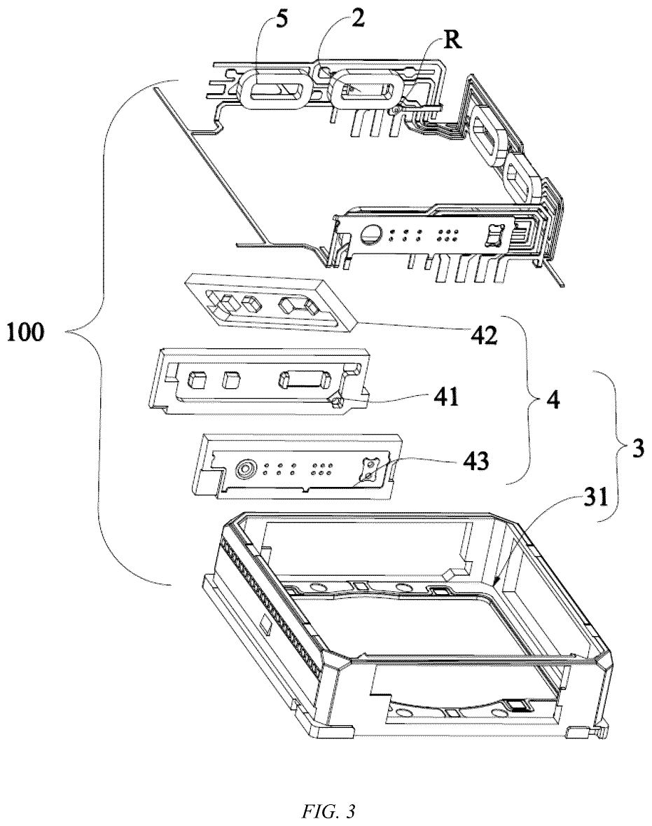

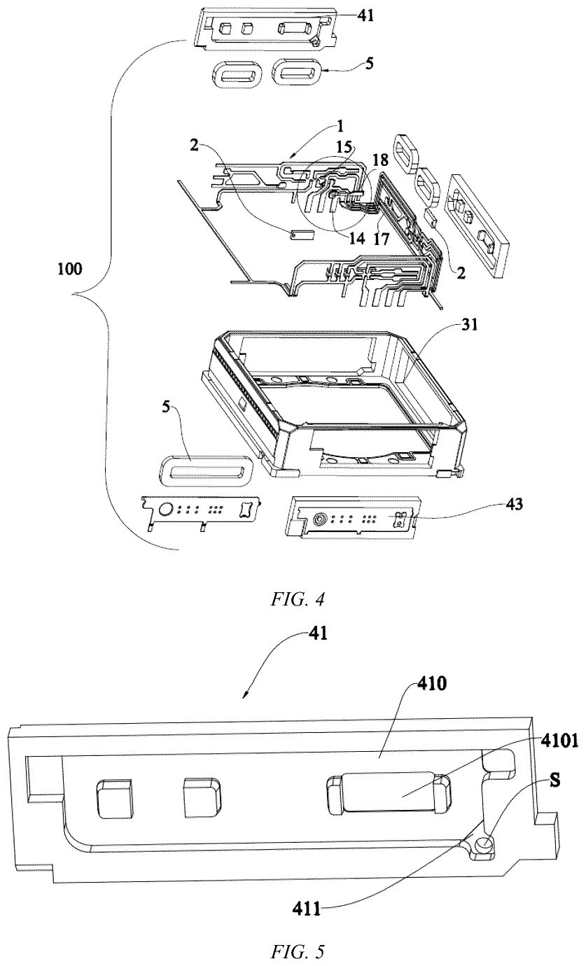

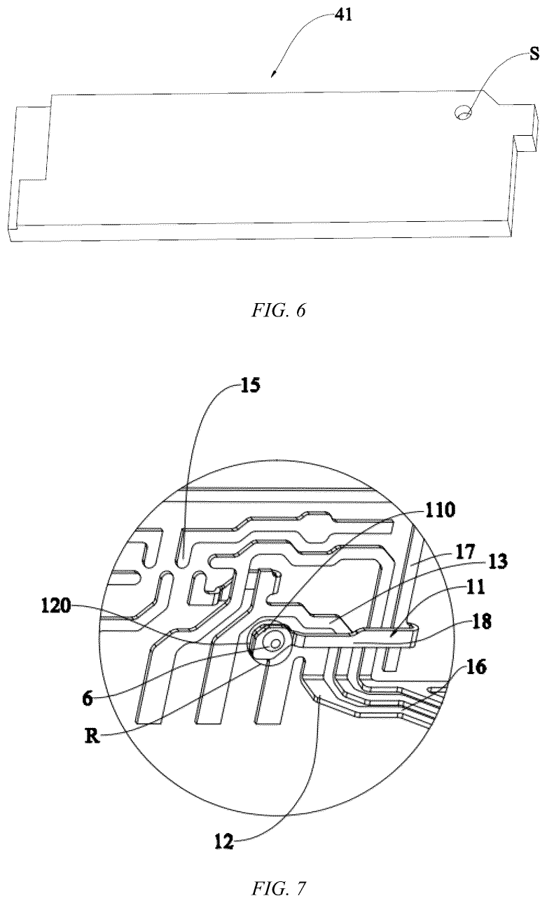

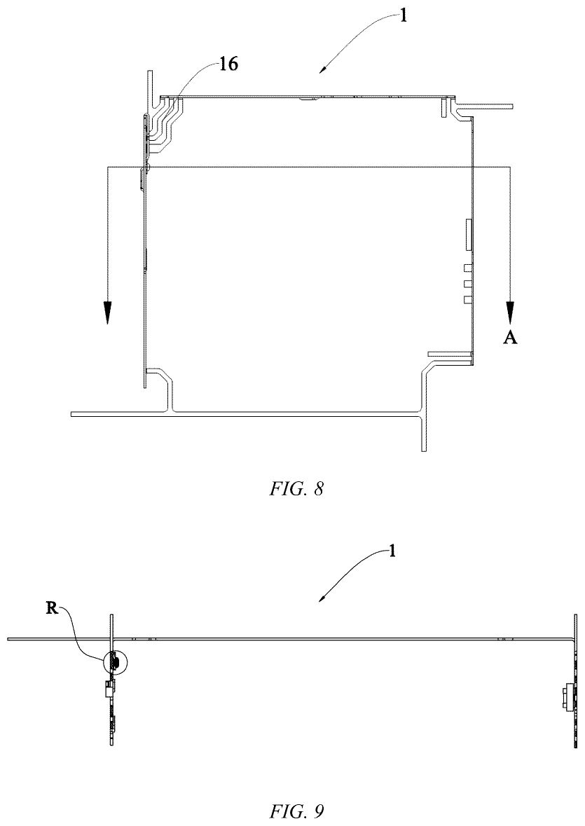

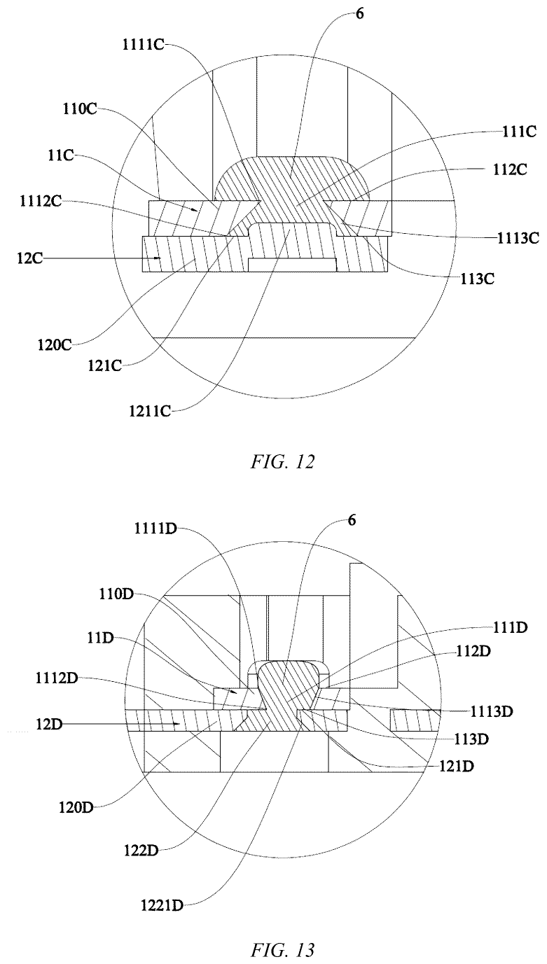

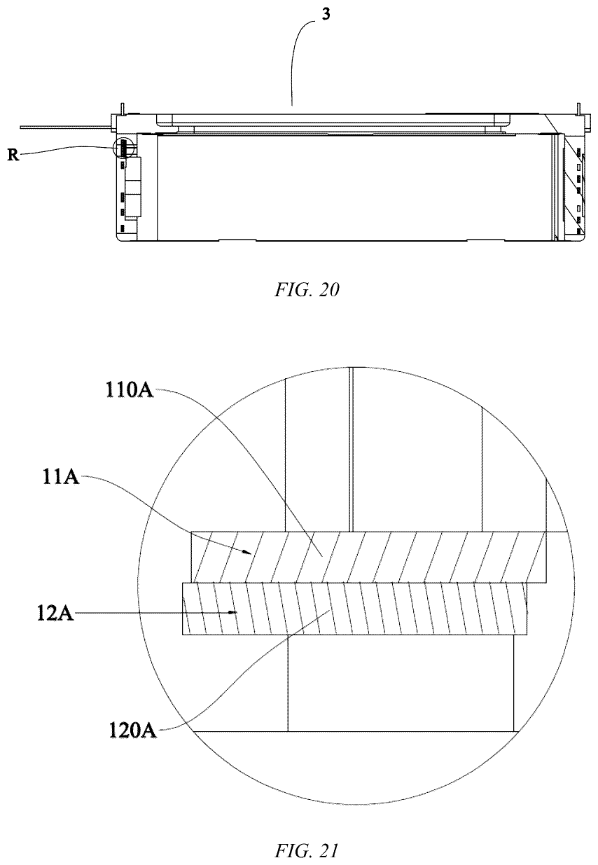

Referring to FIG. 1 to FIG. 27, the motor base 100 includes an insulating base 3, the metal circuit 1 arranged on the insulating base 3, and an electronic element 2 welded to the metal circuit 1. The insulating base 3 includes a plurality of plastic blocks 4 which are formed by one-shot injection molding and cover the metal circuit 1, and a plastic body 31 formed by two-shot injection molding to cover the metal circuit 1 and a plurality of the plastic blocks 4. The electronic element 2 is positioned on the plastic block 4 and exposed to the plastic block 4. In the present invention, the electronic element 2 refers to an electronic element such as an IC chip, a Hall element, a capacitor, or an inductor. Each of the conductive terminals includes a weld leg 15 for welding the electronic element 2 and a connecting section connecting the weld leg 15. In an embodiment of the present application, the metal circuit 1 includes at least two conductive terminals that are connected to different electronic elements 2 and are spaced apart and at least a third conductive terminal arranged between the two conductive terminals, one of the two conductive terminals has a pin end 14 that is connected to the connecting section and exposed outside the insulating base 3, and the two conductive terminals share the pin end 14. In the following embodiments one to eleven of the present application, the two conductive terminals are respectively defined as the first conductive terminal and the second conductive terminal, specifically, the first conductive terminal is respectively defined as the first conductive terminal 11, 11A, 11B, 11C, 11D, 11F, 11G, 11H, 11I, 11J, 11K in all the following embodiments, the second conductive terminal is respectively defined as the second conductive terminal 12, 12A, 12B, 12C, 12D, 12F, 12G, 12H, 12I, 12J, 12K in all the following embodiments, and the third conductive terminal is respectively defined as the third conductive terminal 13, 13K in the following embodiments. Only one of the first conductive terminal and the second conductive terminal is provided with a pin end 14 extending from the corresponding connecting section out of the insulating base 3 to be electrically connected to an external circuit, so that the first conductive terminal and the second conductive terminal share the same pin end 14. The external circuit is a control circuit outside the motor base 100, which is used to transmit an electrical signal to the metal circuit 1 in the motor base 100. In order to enable the first conductive terminal and the second conductive terminal to share the pin end 14, the first conductive terminal and the second conductive terminal both include a lap joint part extending from the connecting section, the lap joint part of the first conductive terminal is defined as a first lap joint part, and the lap joint part of the second conductive terminal is defined as a second lap joint part.

Since there is a third conductive terminal between the two conductive terminals, in order to facilitate the cross-over connection of the two relatively to the third conductive terminal, at least one of the two conductive terminals needs to be provided with a cross-over structure that crosses the third conductive terminal to achieve overlapping connection with the other conductive terminal. In an embodiment of the present application, the first conductive terminal also includes a bridging part connecting the first lap joint part and the corresponding connecting section, and the bridging part is a cross-over structure that crosses the third conductive terminal and is provided on the first conductive terminal. The bridging part spans across the third conductive terminal from the corresponding connecting section so that the first lap joint part overlaps and is fixedly connected with the second lap joint part. The position where the second lap joint part overlaps with the first lap joint part is defined as an overlapping region R. The insulating base 3 is injection molded and covered and fixed outside the two conductive terminals, and the overlapping region R is exposed to the plastic block 4 of the insulating base 3.

In the following embodiments one to eleven of the present application, the first lap joint parts belonging to different first conductive terminals 11, 11A, 11B, 11C, 11D, 11F, 11G, 11H, 11I, 11J, 11K are respectively defined as the first lap joint part 110, 110A, 110B, 110C, 110D, 110F, 110G, 110H, 110I, 110J, 110K, and the second lap joint parts belonging to different second conductive terminals 12, 12A, 12B, 12C, 12D, 12F, 12G, 12H, 12I, 12J, and 12K are respectively second lap joint part 120, 120A, 120B, 120C, 120D/120F, 120G/120H, 120I, 120J, and 120K, the connecting sections belonging to different first conductive terminals 11, 11K are respectively connecting sections 17, 17K, and the bridging parts belonging to different first conductive terminals 11, 11K are respectively defined as 18, 18K.

The plastic body 31 is formed by two-shot injection molding on the metal circuit 1 and the plastic block 4, the plurality of plastic blocks 4 are located on different planes perpendicular to the plastic body 31, the electronic elements 2 are respectively located on and exposed to the plastic blocks 4 on different planes, thus, the weld legs 15 of the conductive terminals are all welded to the electronic elements 2 and are also required to be located on and exposed to the plastic blocks 4 on different planes. The weld leg 15, the first lap joint part, and the second lap joint part are all exposed on the same surface of the corresponding plastic block 4. In the embodiment of the present application, the plastic block 4 includes a first retaining wall 41 perpendicular to the bottom surface of the plastic body 31, a second retaining wall 42 perpendicular to the bottom surface of the plastic body 31 and adjacent to and perpendicular to the first retaining wall 41, and a third retaining wall 43 perpendicular to the bottom surface of the plastic body 31 and parallel to the first retaining wall 41 and connected to the second retaining wall 42. The plane where the first retaining wall 41 is located is the first plane P1, the plane where the second retaining wall 42 is located is the second plane P2, the plane where the third retaining wall 43 is located is the third plane P3, and the plane where the bottom surface of the plastic body 31 is located is the fourth plane P4. The first retaining wall 41, the second retaining wall 42 and the third retaining wall 43 are all provided with coils 5, wherein two coils 5 are installed on the first retaining wall 41 and the second retaining wall 42 to prevent shaking during video recording, and a coil 5 is installed on the third retaining wall 43 to drive zoom. One of the electronic elements 2 is welded to the weld leg 15 of the first conductive terminal held by the first retaining wall 41, and the other electronic element 2 is welded to the weld leg 15 of the second conductive terminal held by the second retaining wall 42. Of course, in other embodiments, the electronic element 2 is also welded to the weld leg 15 of the second conductive terminal held by the third retaining wall 43, and it is only necessary to meet the second lap joint part of the second conductive terminal overlapping the first lap joint part in three directions. In the present invention, the connecting section 17 of the second conductive terminal extends from the corresponding weld leg 15 and continuously spans at least three planes, the connecting section 17 spans from the vertical plane where the weld leg of the second conductive terminal is located to the horizontal plane where the bottom surface of the plastic body is located, and then crosses to the vertical plane where the weld leg of the first conductive terminal is located. Specifically, the connecting section 17 of the second conductive terminal crosses from the second plane P2 to the fourth plane P4, and then crosses to the first plane P1, thereby completing the overlapping of the two conductive terminals. Since the second lap joint part needs to cross to the fourth plane P4, the second conductive terminal is also provided with a spanning segment 16 fixed to the insulating base 3, which can enhance the strength of the motor base 100 while achieving the crossing.

In an embodiment of the present application, the materials of the first conductive terminal and the second conductive terminal can be selected to be the same or different. In the present embodiment, specifically, the material of the first conductive terminal is copper, and the material of the second conductive terminal is stainless steel. In an embodiment of the present application, the thickness of the first conductive terminal and the second conductive terminal can also be different, for example, the thickness of the first conductive terminal is designed to be greater than the thickness of the second conductive terminal, in this way, the overall thickness after the overlap of the two can be reduced, and the subsequent injection molding thickness of the insulating base 3 can be reduced. In an embodiment of the present application, the thickness of the first conductive terminal made of copper is 0.08 mm, and the thickness of the second conductive terminal made of stainless steel is 0.05 mm.

In this embodiment, after the first conductive terminal and the second conductive terminal are overlapped and arranged, a positioning fixture is used to relatively position the overlapping region R of the two, and the relative positioning of the two conductive terminals is achieved by one-shot injection molding of the plastic block 4. In this embodiment, the specific positioning fixture can be a pin fixture. After injection molding the plastic block 4, the pin fixture is removed, and the plastic block 4 forms a concave hole S corresponding to the overlapping region R, the overlapping region R of the first lap joint part of the first conductive terminal and the second lap joint part of the second conductive terminal is exposed to the plastic block 4 on the opposite side of the concave hole S. The plastic block 4 is provided with a loading slot 410 for bearing the electronic element 2 on the opposite side of the concave hole S. The loading slot 410 is further recessed with a depression groove 4101, the top surface of the weld leg 15 of the conductive terminal is exposed to the bottom surface of the depression groove 4101, so as to facilitate the electrical welding of the electronic element 2 and the weld leg 15 arranged in the loading slot 410. Since the thickness of the overlapping region R is greater than the thickness of the weld leg 15 after the first lap joint part and the second lap joint part overlap each other, the top surface of the lap joint part is higher than the top surface of the weld leg 15, in order to facilitate the plastic block 4 to cover part of the overlapping region R and expose the electrical connection area between the two, the loading slot 410 is provided with a step section 411 protruding from the bottom wall of the loading slot 410, and the step section 411 corresponds to the overlapping region R to cover the first lap joint part and the second lap joint part.

In the present application, although the two conductive terminals have been overlapped by cross-line bending, in order to further enhance the fixing and electrical connection performance, the overlapping region R of the two conductive terminals needs to be further electrically connected. The following is a detailed description of how to further electrically connection of the two conductive terminals through the introduction of embodiments one to eleven of the present application.

Please refer to FIG. 1 to FIG. 27 for details. After the two conductive terminals are overlapped by cross-line bending, the two conductive terminals are subsequently fixedly connected and electrically connected, the specific fixed connection and electrical connection processing methods can be selected from welding tin material and reflow furnace (also known as SMT welding), resistance welding, laser welding and other processing methods. In addition to the welding processing methods illustrated above, some mechanical fixing processing methods such as riveting and stamping can also be used to achieve mutual fixation and electrical connection between the two.

In the first to sixth embodiments of the present application, soldering, i.e., surface mount welding technology (SMT welding technology), is specifically selected to realize the fixed connection and electrical connection between the two conductive terminals. Specifically, welding the tin material 6 is positioned in the overlapping region R of the two conductive terminals, in order to facilitate the full contact and coverage of the tin material 6 with the welding area, at least one of the first lap joint part and the second lap joint part is provided with a hole for accommodating the tin material 6 in the overlapping region R. After the plastic block 4 is injection molding, the first conductive terminal and the second conductive terminal are soldered with tin material 6 in the overlapping region R and are welded in a reflow furnace, and then the plastic body 31 is two-shot injection molding. It can be understood that during the welding process, in order to avoid the problem of poor tinning or poor contact after welding, the surface of the overlapping region R of the first conductive terminal and the second conductive terminal is gold-plated to form a gold-plated region (unnumbered), and then tin is plated on the outside of the gold-plated region through a welding process to achieve welding fixation. The gold-plated region can isolate the copper metal of the conductive terminal from the air to prevent oxidation of the conductive terminal. The gold-plated region specifically covers the upper surface of the first conductive terminal in the overlapping region R and the lower surface arranged opposite to the upper surface, the inner wall of the hole, and the upper wall of the second conductive terminal arranged relatively close to the lower surface of the first conductive terminal. Since the wettability and ductility of gold are better than other metals, when the tin material 6 is applied in the hole, the tin material 6 is more easily adsorbed in the gold-plated region. In the embodiments of the present application, the specific embodiments of using surface mount soldering technology (SMT soldering technology) to achieve welding fixation between two conductive terminals include 6 kinds, which are respectively the first to the sixth embodiments.

In first embodiment of the present application, please refer to FIG. 1 to FIG. 10, the first lap joint part 110 of the first conductive terminal 11 is provided with the hole in the overlapping region R, and the hole is defined as a holding through-hole 111. The inner wall is defined as a first inner wall 1113 provided with the holding through-hole 111. The holding through-hole 111 is provided with an opening end 1111 away from the second conductive terminal 12, a resting end 1112 near to the second conductive terminal 12, and the first inner wall 1113. And the first lap joint part 110 is provided with the upper surface 112 and the lower surface 113 in the overlapping region R. The second lap joint part 120 of the second conductive terminal 12 has an upper wall 121 provided opposite to the lower surface 113. The gold-plated region is provided on the upper surface 112, the lower surface 113, the first inner wall 1113, and the upper wall 121, so that the tin material 6 is more easily in full contact with the holding through-hole 111, and stable welding between the lap joint parts of the two conductive terminals is achieved. At the same time, in the first embodiment of the present application, the size of the opening end 1111 of the holding through-hole 111 is designed to be smaller than the size of the resting end 1112. In the process of welding the tin material 6, the tin material 6 is less likely to fall from the holding through-hole 111, thereby ensuring the welding effect between the two conductive terminals and enhancing the electrical connection performance.

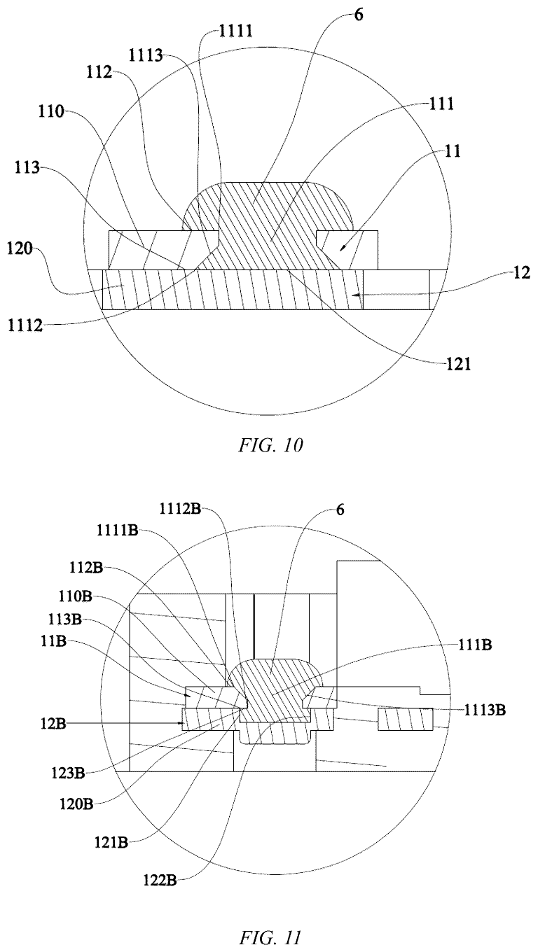

In the second embodiment of the present application, please refer to FIG. 11, the first lap joint part 110B of the first conductive terminal 11B and the second lap joint part 120B of the second conductive terminal 12B are both provided with the holes in the overlapping region R. The hole of the first lap joint part 110B is defined as the holding through-hole 111B, and the inner wall is defined as the first inner wall 1113B provided for the holding through-hole 111B. The holding through-hole 111B is provided with an opening end 1111B away from the second conductive terminal 12B, a resting end 1112B near to the second conductive terminal 12B, and the first inner wall 1113B. In the second embodiment, the size of the opening end 1111B is designed to be larger than the size of the resting end 1112B. The hole of the second lap joint part 120B is defined as a receiving hole 121B connected to the holding through-hole 111B. The inner wall of the second lap joint part 120B is defined as a second inner wall 122B provided for the receiving hole 121B. The size of the receiving hole 121B is larger than the size of the resting end 1112B. Such a configuration can make it easier for the tin material 6 to enter the holding through-hole 111B and be accommodated in the holding through-hole 111B and the receiving hole 121B. The gold-plated region is provided on the upper surface 112B, the lower surface 113B, the first inner wall 1113B, the second inner wall 122B and the upper wall 123B of the first conductive terminal 11B, so that the tin material 6 can more easily fully contact the retaining through hole holding through-hole 111B and the receiving hole 121B, and better achieve welding between the lap joint parts of the two conductive terminals. Since the second lap joint part 120B of the second conductive terminal 12B is recessed downward to form the receiving hole 121B, the tin material 6 can enter the receiving hole 121B after passing through the holding through-hole 111B, on the basis of the capacity of the holding through-hole 111B, to further improve the ability to accommodate the tin material 6, moreover, since the size of the receiving hole 121B is larger than the size of the resting end 1112B, the tin material 6 can be clamped in the receiving hole 121B and is not easy to fall off.

In the third embodiment of the present application, please refer to FIG. 10, the first lap joint part 110C of the first conductive terminal 11C is provided with the hole in the overlapping region R. The hole is defined as a holding through-hole 111C. The inner wall is defined as a first inner wall 1113C provided for the holding through-hole 111C. The holding through-hole 111C is provided with an opening end 1111C away from the second conductive terminal 12C and a resting end 1112C near to the second conductive terminal 12C. In the third embodiment, the size of the opening end 1111C is designed to be smaller than the size of the resting end 1112C. The second lap joint part 120C of the second conductive terminal 12C is provided with a bulge 1211C protruding from the upper wall 121C into the holding through-hole 111C, and the tin material 6 is accommodated in the holding through-hole 111C and concentratedly distributed in the peripheral area of the bulge 1211C. The bulge 1211C is arranged on the second lap joint part 120C. On the one hand, the first conductive terminal 11C and the second conductive terminal 12C can be initially positioned, the positioning effect in the process can be optimized and the welding fixing effect can be enhanced. On the other hand, when soldering, the contact area between the tin material 6 and the first lap joint part 110C and the second lap joint part 120C can be further increased, so that the contact area is larger and the contact is more sufficient. The gold-plated region is arranged on the upper surface 112C, the lower surface 113C, the first inner wall 1113C, the outer area of the bulge 1211C and the upper wall 121C of the first conductive terminal 11C, so that the tin material 6 can more easily fully contact the holding through-hole 111C, and realize the welding between the lap joint parts of the two conductive terminals.

In the fourth embodiment of the present application, please refer to FIG. 13, the first lap joint part 110D of the first conductive terminal 11D and the second lap joint part 120D of the second conductive terminal 12D are both provided with the hole in the overlapping region R, and the hole of the first lap joint part 110D is defined as a holding through-hole 111D. The inner wall is defined as a first inner wall 1113D provided with the holding through-hole 111D. The holding through-hole 111D is provided with an opening end 1111D away from the second conductive terminal 12D, a resting end 1112D near to the second conductive terminal 12D, and the first inner wall 1113D. In the fourth embodiment, the size of the opening end 1111D is designed to be larger than the size of the resting end 1112D to facilitate the entry of the tin material 6. The hole of the second lap joint part 120D is defined as a receiving hole 122D which is staggered and partially connected with the holding through-hole 111D. The inner wall of the receiving hole 122D is defined as a second inner wall 1221D. The size of the side of the receiving hole 122D close to the first lap joint part 110D is smaller than the size of the side of the receiving hole 122D away from the first lap joint part 110D, that is, the receiving hole 122D is a tapered structure in the direction close to the first lap joint part 110D, and the tin material 6 enters through the holding through-hole 111D and is contained in the holding through-hole 111D and the receiving hole 122D. By controlling the amount of the tin material 6, even if there is a connecting section between the first conductive terminal 11D and the second conductive terminal 12D, the tin material 6 will not drip out of the receiving hole 122D. The gold-plated region is arranged on the upper surface 112D, the lower surface 113D, the first inner wall 1113D, the second inner wall 1221D and the upper wall 121D of the first conductive terminal 11D, so that the tin material 6 can more easily and fully contact the holding through-hole 111D and the receiving hole 122D to achieve welding between the lap joint parts of the two conductive terminals.

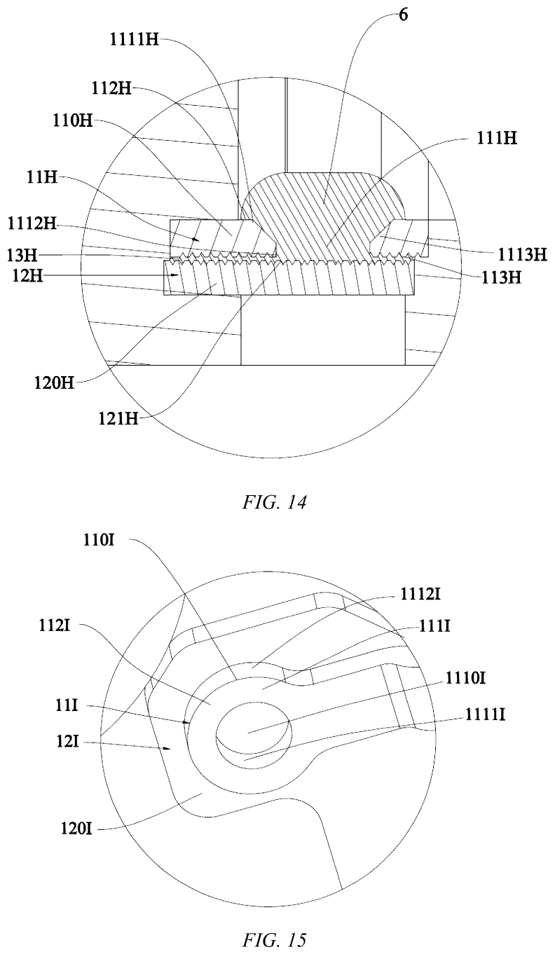

In one fifth embodiment of the present application, please refer to FIG. 14, the first lap joint part 110H of the first conductive terminal 11H is provided with the hole in the overlapping region R, the hole is defined as a holding through-hole 111H, and the inner wall is defined as a first inner wall 1113H provided in the holding through-hole 111H. The holding through-hole 111H is provided with an opening end 1111H away from the second conductive terminal 12H, a resting end 1112H near to the second conductive terminal 12H, and the first inner wall 1113H. In the fifth embodiment, the size of the opening end 1111H is designed to be larger than the size of the resting end 1112H to facilitate the entry of the tin material 6. The first conductive terminal 11H and the second conductive terminal 12H are both provided with a wavy-like concave-convex structure 13H on the lower surface 113H and the upper wall 121H in the overlapping region R, and the concave-convex structure 13H of the lower surface 113H and the concave-convex structure 13H of the upper wall 121H extend in different directions, and the tin material 6 enters from the holding through-hole 111H and is accommodated in the concavo-convex structure 13H between the holding through-hole 111H and the lower surface 113H and the upper wall 121H. Since the lower surface 113H and the upper wall 121H are both provided with mutually displaced and embedded wavy-like concave-convex structures 13H, a point-to-point contact form is formed, making the positioning contact between the two more reliable, and a certain gap is formed between the wavy-like concave-convex structures 13H, which is more convenient for sufficient soldering when welding the tin material 6. The gold-plated region is arranged on the upper surface 112H, the lower surface 113H, the first inner wall 1113H and the upper wall 121H of the first conductive terminal 11H, so that the tin material 6 can more easily fully contact the holding through-hole 111H, so as to realize the welding between the lap joint parts of the two conductive terminals.

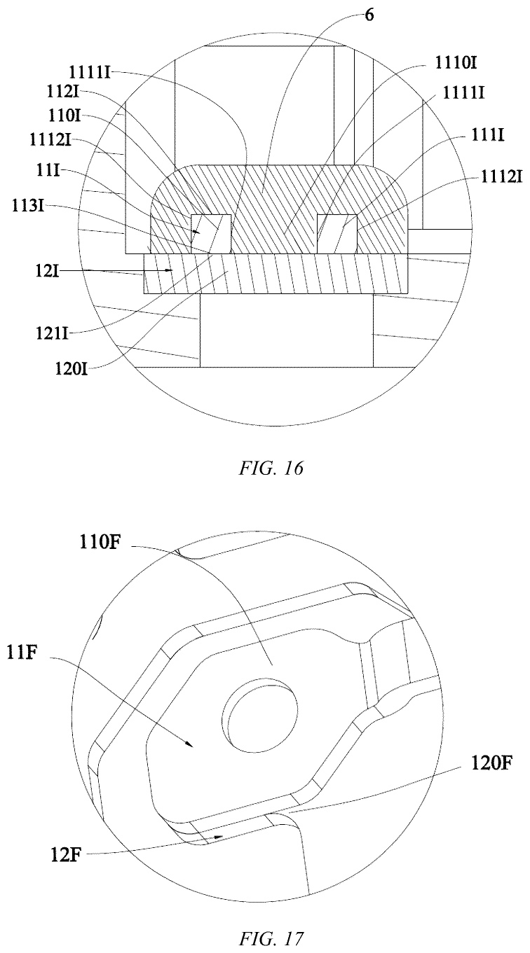

In one sixth embodiment of the present application, please refer to FIG. 15 and FIG. 16, the area of the first lap joint part 110I of the first conductive terminal 11I is smaller than the area of the second lap joint part 120I of the second conductive terminal 12I. The first lap joint part 110I has a ring structure 111I, and the ring structure 111I is hollowly arranged to form the hole. The hole of the ring structure 111I is defined as the holding through-hole 1110I, and the inner wall is defined as the first inner wall 1111I provided with the holding through-hole 1110I. The outer wall of the ring structure 111I is defined as the outer wall surface 1112I. The second lap joint part 120I is disposed on one side of the ring structure 111I, and the tin material 6 covers the ring structure 111I along the second lap joint part 120I and is fully contained in the outer wall surface 1112I of the ring structure 111I and the holding through-hole 1110I, thereby strengthening the full contact between the tin material 6 and the two conductive terminals and ensuring the welding effect. The gold-plated region is disposed on the upper surface 112I, the lower surface 113I, the outer wall surface 1112I, the first inner wall 1111I and the upper wall 121I of the first conductive terminal 11I located in the overlapping region R, so that the tin material 6 can more easily fully contact the ring structure 111I and the upper wall 1211 of the second lap joint part 120I, thereby achieving welding between the first lap joint part 110I and the second lap joint part 120I of the two conductive terminals.

In the first to sixth embodiments of the present application, the electronic element 2 and the weld leg 15 are welded by surface mount welding (SMT—Surface Mounting Technology). Since the metal circuit 1 and the electronic element 2 need to be welded by an SMT welding process, in the first to sixth embodiments of the present application, the tin material 6 and the pre-positioning action can be performed in the hole of the first conductive terminal and/or the second conductive terminal first, and then the mutual welding and fixing can be completed by the welding process of the electronic element 2, and there is no need to add an independent welding process to the first conductive terminal and the second conductive terminal.

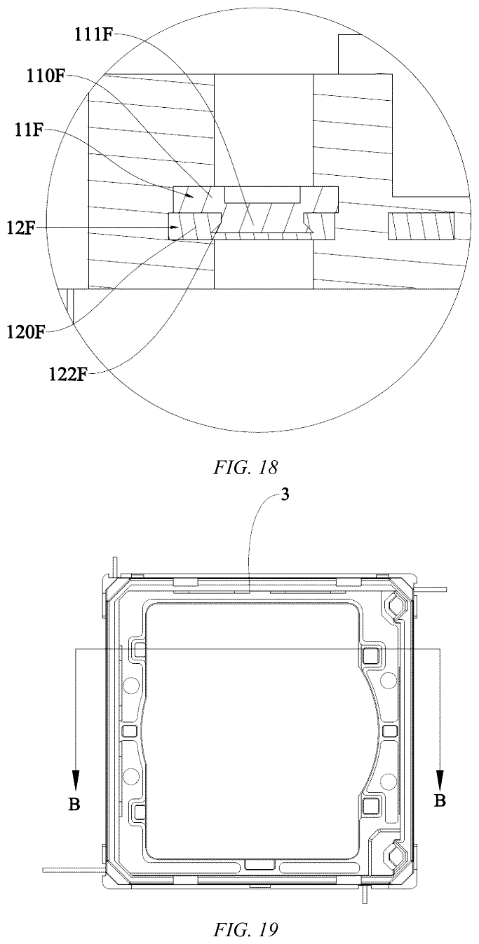

In other embodiments of the present application, in order to achieve the fixed connection and electrical connection processing of the overlapping parts of the two conductive terminals in the overlapping region R, in addition to the above-mentioned welding the tin material 6 and then performing SMT welding, the mechanical fixation between the two can also be achieved by mechanical fixation and electrical conduction at the same time. In the seventh embodiment of the present application, please refer to FIG. 17 and FIG. 18, the first lap joint part 110F of the first conductive terminal 11F and the second lap joint part 120F of the second conductive terminal 12F are fixedly connected in the overlapping region R by mechanical riveting, more specifically, by cold heading riveting. The first lap joint part 110F is provided with a protruding portion 111F protruding downward by cold heading, and the second lap joint part 120F is provided with a receiving hole 122F for accommodating the protruding portion 111F in the overlapping region R. In the seventh embodiment of the present application, the riveting fixing method requires an additional riveting fixing process relative to the welding fixing method of the first to sixth embodiments of the present application. However, the riveting fixing method can achieve a fixed connection and an electrical connection between the two at one time. In other embodiments, the mechanical fixing method can also specifically adopt mechanical fixing methods such as crimping fixing and clamping fixing, so as to achieve electrical connection while achieving fixed connection.

In other embodiments of the present application, in order to achieve the fixation and electrical connection processing of the overlapping parts of the two conductive terminals in the overlapping region R, in addition to the above-mentioned fixing means by welding tin material 6 and then performing SMT welding and fixing, other welding processes can also be used to achieve it. In the eighth embodiment of the present application, please refer to FIG. 19 to FIG. 21, the first lap joint part 110A of the first conductive terminal 11A is arranged in parallel and overlapped with the second lap joint part 120A of the second conductive terminal 12A in the overlapping region R. Specifically, the overlapping region R of the two conductive terminals are further connected and fixed to each other by resistance welding or laser welding. Because resistance welding cannot utilize the welding process of the reflow furnace, the welding and fixing methods of resistance welding or laser welding need to provide additional targeted welding processes relative to the welding and fixing methods of the first to sixth embodiments of the present application. However, for some common motor bases, such as those without other electronic elements to be welded, since there is no need to position the weld legs for welding with electronic elements in advance, the insulating base 3 can be welded first and then the injection molding can be completed. Compared with the need to inject the plastic block 4 and the plastic body 31 in batches, the injection molding process can be saved.

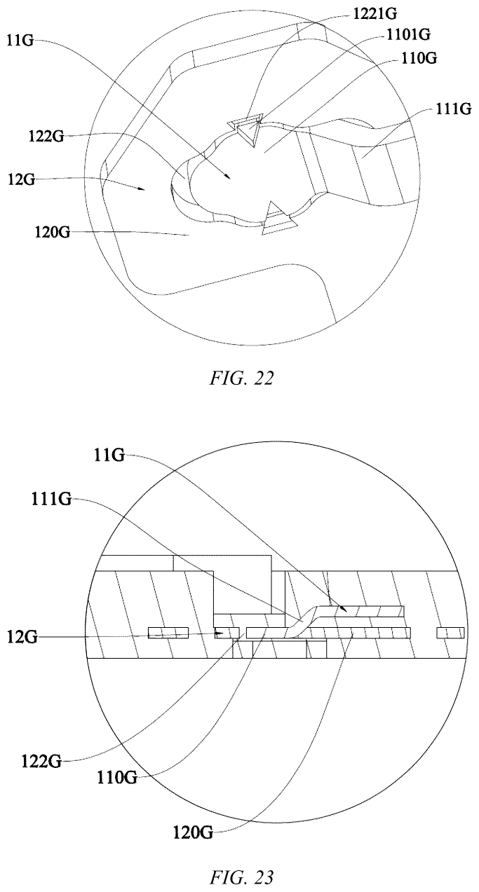

In other embodiments of the present application, in order to achieve the fixation and electrical connection of the lap joint parts of the two conductive terminals in the overlapping region R, a stamping and welding process can also be used. In the ninth embodiment of the present application, please refer to FIG. 22 to FIG. 23, the first lap joint part 110G of the first conductive terminal 11G is stamped into the receiving hole 122G opened by the second lap joint part 120G of the second conductive terminal 12G in the overlapping region R, and then further welded and fixed. During the stamping process, the bridging part of the first conductive terminal 11G forms a bending part 111G, so that the first lap joint part 110G and the second lap joint part 120G locating in the same plane. When the first lap joint part 110G is punched in the receiving hole 122G of the second lap joint part 120G, the first lap joint part 110G is deformed and expanded and then directly tensioned and fixedly contacted with the second lap joint part 120G, and then welded and fixed, so as to strengthen the direct contact between the two and enhance the electrical connection performance. The first lap joint part 110G is provided with a pair of clamping blocks 1101G arranged opposite to each other, and the second lap joint part 120G is provided with a pair of gaps 1221G opposite to the clamping blocks 1101G. The clamping blocks 1101G and the gaps 1221G cooperate with each other, and after the first lap joint part 110G is deformed and expanded, it is difficult for the first lap joint part 110G to be separated from the receiving hole 122G provided in the second lap joint part 120G. In other embodiments, after the second lap joint part 120G is bent across the line and overlaps the first lap joint part 110G, in order to further enhance the electrical connection performance between the two, other corresponding changes may be made to the structures of the first lap joint part 110G and the second lap joint part 120G to enhance the connection fixation between the two.

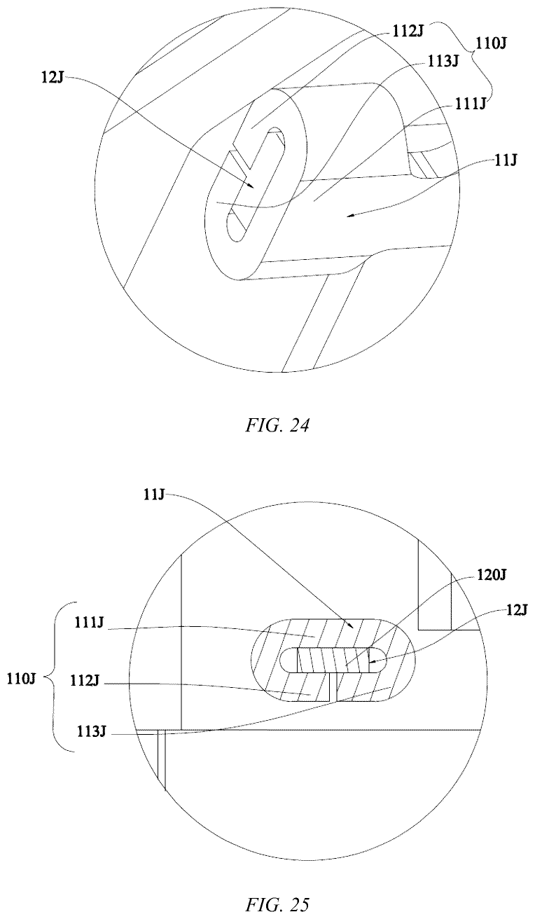

In the tenth embodiment of the present application, please refer to FIG. 24 and FIG. 25, the first lap joint part 110J of the first conductive terminal 11J wraps the second lap joint part 120J of the second conductive terminal 12J in the overlapping region R by cold heading and riveting, so that the two are mechanically fixed and electrically connected at the same time. Specifically, the first lap joint part 110J includes a main body 111J arranged parallel to the second lap joint part 120J and a first bending stage 112J and a second bending stage 113J formed by bending and wrapping from both sides of the main body 111J to the second lap joint part 120J. The main body 111J, the first bending stage 112J and the second bending stage 113J wrap and fix the second lap joint part 120J, and then connect and fix the two by cold heading.

In the embodiment of the present application, the bridging part is integrally bent and extended from the connecting section of the first conductive terminal or is separately arranged from the connecting section. In the above embodiments of the present application, namely the first to tenth embodiments, the bridging part is integrally bent and extended from the connecting section of the first conductive terminal; in one of the eleventh embodiments of the present application, the bridging part 18K and the connecting section 17K of the first conductive terminal 11K are separately provided, and the two are also fixed and electrically connected to each other by overlapping. The bridging part 18K and the connecting section 17K of the first conductive terminal 11K are separately provided, which can further reduce the bending of the conductive terminal, facilitate the spatial span of the first conductive terminal 11K relative to the third conductive terminal 13K, and minimize the path of the first conductive terminal 11K; on the other hand, since the bridging part 18K can be regarded as an additional metal material segment relative to the first conductive terminal 11K, a different material and different material thickness can be selected from the first conductive terminal 11K and the second conductive terminal 12K, so that the resistivity of the conductive path can be adjusted while more flexibly controlling the welding method between the first conductive terminal 11K and the second conductive terminal 12K, further enhancing the electrical connection effect between the two conductive terminals.

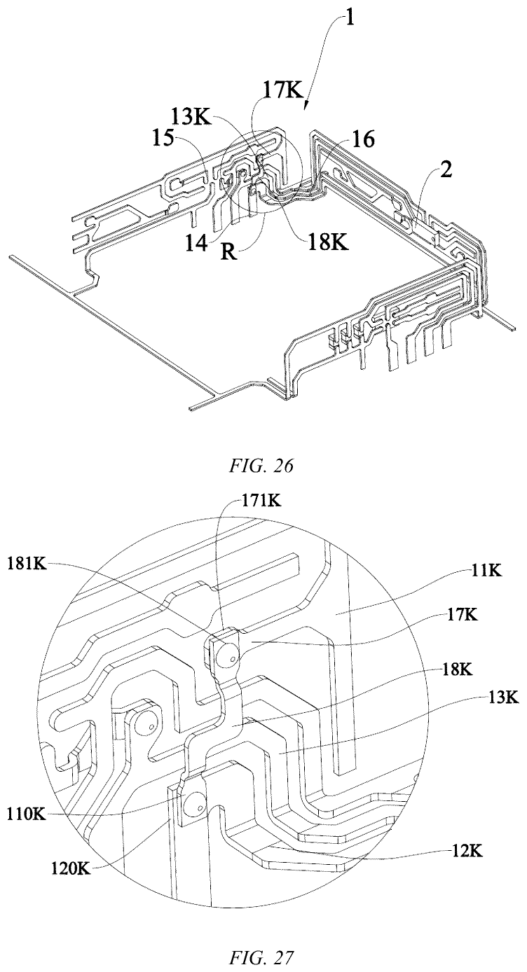

Please refer to FIG. 26 and FIG. 27, the first lap joint part 110K is electrically connected to the second lap joint part 120K of the second conductive terminal 12K through a bridging part 18K. The bridging part 18K crosses the third conductive terminal 13K so that the first lap joint part 110K overlaps with the second lap joint part 120K. The connecting section 17K of the first conductive terminal 11K is further provided with a third lap joint part 171K, and the bridging part 18K is further provided with a fourth lap joint part 181K. The first lap joint part 110K and the fourth lap joint part 181K of the first conductive terminal 11K are respectively located at two ends of the bridging part 18K. The third lap joint part 171K and the fourth lap joint part 181K overlap and overlap and are fixed and electrically connected. In this embodiment, the thickness of the bridging part 18K is smaller than the thickness of the connecting section 17K of the first conductive terminal 11K and the second conductive terminal 12K, so that the thickness of the subsequent plastic block 4 can be reduced while achieving electrical connection. The provision of the bridging part 18K reduces the bending of the second conductive terminal 12K, increases the overlap fixing points to reduce the path of the conductive terminal. The portion of the bridging part 18K that does not overlap with the first conductive terminal 11K and the second conductive terminal 12K is provided with an insulating coating (not marked) at least on one side facing the third conductive terminal 13K so that the bridging part 18K is directly attached to the third conductive terminal 13K to prevent short circuit, and can further reduce the thickness of the subsequent plastic block 4. A plastic block 4 is injection molded outside the metal circuit 1, and the lap joint part (the fourth lap joint part 181K) of the bridging part 18K and the first conductive terminal 11K and the lap joint part (the first lap joint part 110K) of the bridging part 18K and the second conductive terminal 12K are exposed to the plastic block 4, and the portion of the bridging part 18K that does not overlap with the first conductive terminal 11K and the second conductive terminal 12K is covered by the plastic block 4. In addition, since the bridging part 18K is separated from the first conductive terminal 11K, the material of the bridging part 18K can be changed. If the resistance caused by the first conductive terminal 11K crossing the line is large, the impedance of the entire metal circuit 1 can be adjusted by changing the material of the bridging part 18K. It can be understood that in this embodiment, the fixed connection and electrical connection method of the bridging part 18K and the first conductive terminal 11K and the second conductive terminal 12K can be selected from any one of the above first embodiment to the tenth embodiment.

The present invention also relates to a manufacturing method for manufacturing a motor base 100, specifically including the following steps:
Step 1: Providing a metal circuit 1 with a plurality of conductive terminals, the conductive terminals include a first conductive terminal, a second conductive terminal, and a third conductive terminal arranged between the first conductive terminal and the second conductive terminal, each conductive terminal includes a weld leg and a connecting section extending from the weld leg 15, the first conductive terminal includes a bridging part connected to the connecting section and a first lap joint part extending from the bridging part, the second conductive terminal includes a second lap joint part extending from the corresponding connecting section, the bridging part spans across the third conductive terminal from the corresponding connecting section, causing the first lap joint part to overlap with the second lap joint part.
Step 2: Performing one-shot injection molding to form a plurality of plastic blocks 4 for holding the metal circuit 1, and the weld leg 15 and the lap joint part are exposed to the plastic block 4; after the first conductive terminal and the second conductive terminal are overlapped and arranged, a pin fixture is used to top-jointly position the first conductive terminal and the second conductive terminal, so as to facilitate one-shot injection molding of the plastic block 4 around the lap joint part;
Step 3: Position a plurality of electronic elements 2 on the corresponding plastic block 4 and weld them with the corresponding weld legs 15;
Step 4: Defining the overlapping area of the second lap joint part and the first lap joint part as an overlapping region. In the overlapping region, the first lap joint part and the second lap joint part are fixedly connected. The fixed connection processing method is selected from any one of surface mount welding, riveting, laser welding or resistance welding;
Step 5: Performing two-shot injection molding of the plastic body 31 outside the metal circuit 1 and the plastic block 4 to form an insulating base 3, thereby forming a motor base 100.

In the Step 4, the first lap joint part and the second lap joint part are subjected to surface mount welding, the first lap joint part and the second lap joint part are welded with tin material 6 in the overlapping region R, and then welded in a reflow furnace.

When the two conductive terminals are fixedly connected by surface mount welding, at least one of the first lap joint part and the second lap joint part is provided with a hole for accommodating the tin material 6 in the overlapping region R.

When the two conductive terminals are fixedly connected by laser welding or resistance welding, the first lap joint part and the second lap joint part are arranged in parallel and overlapped in the overlapping region, so as to facilitate laser welding or resistance welding of the first lap joint part and the second lap joint part.

When the two conductive terminals are fixedly connected by riveting, the first lap joint part and the second lap joint part are riveted and fixed in the overlapping region, specifically by cold heading to make the first lap joint part protrude downward with a protruding portion 111F, and the second lap joint part is provided with a receiving hole 122F for accommodating the protruding portion in the overlapping region.

When the two conductive terminals are fixedly connected by riveting, the first lap joint part is riveted to wrap the second lap joint part in the overlapping region, specifically by cold-heading riveting.

While the lap joint parts of the two conductive terminals are connected and fixed by welding, laser welding or resistance welding, the first conductive terminal 11K can also be separately provided with a bridging part 18K, specifically, the bridging part 18K is separately provided with the connecting section 17K of the first conductive terminal 11K. At this time, the connecting section 17K of the first conductive terminal 11K is also provided with a third lap joint part 171K, and the two ends of the bridging part 18K are respectively provided with a first lap joint part 110K and a fourth lap joint part 181K. The fourth lap joint part 181K of the bridging part 18K overlaps and is fixedly connected with the third lap joint part 171K of the first conductive terminal 11K, and the first lap joint part 110K of the bridging part 18K overlaps with, fixes and connects with the second lap joint part 120K of the second conductive terminal 12K, thereby realizing indirect electrical connection between the first conductive terminal 11K and the second conductive terminal 12K. The fixing and electrical connection between the bridging part 18K and the second lap joint part 120K and the third lap joint part 171K may be performed by soldering, resistance welding, laser welding or riveting, etc., which will not be described in detail here.

In the present invention, the bridging part of the first conductive terminal in the motor base 100 spans the third conductive terminal from the connecting section corresponding to the first conductive terminal, so that the first lap joint part overlaps and is fixedly connected with the second lap joint part, thereby avoiding the failure of the conductive terminal to be formed due to excessive bending times of a single conductive terminal, improving the forming yield of the conductive terminal, saving the wiring space of the conductive terminal, and the overlapping region of the two conductive terminals makes the contact area between the two larger, and the electrical connection performance is excellent.

In the first to sixth embodiments of the present invention, after the first lap joint part and the second lap joint part of the first conductive terminal and the second conductive terminal are relatively positioned, the relative electrical connection is completed simultaneously by using the welding process of the electronic element 2, which can further reduce the welding process and simplify the process.

In the first to sixth embodiments of the present invention, at least one of the first lap joint part and the second lap joint part of the first conductive terminal and the second conductive terminal is provided with a hole to promote the full contact between the tin material 6 and the first lap joint part and the second lap joint part, and enhance the welding effect. The portions of the first lap joint part and the second lap joint part of the first conductive terminal and the second conductive terminal that contact the tin material 6 are both provided with a gold-plated region to further enhance the full contact between the tin material and the first lap joint part and the second lap joint part, and enhance the welding effect.

In the present invention, the plastic block 4 has a step section 411 protruding in the loading slot 410 corresponding to the first lap joint part and the second lap joint part of the first conductive terminal and the second conductive terminal or the first lap joint part and the fourth lap joint part of the corresponding bridging part 18K and the second lap joint part and the third lap joint part of the second conductive terminal and the first conductive terminal. The step section 411 covers the outer edge area of the first lap joint part and the second lap joint part or the third lap joint part and the fourth lap joint part, so that only the welding area in the overlapping region R is exposed to the plastic block 4, thereby strengthening the fixing effect of the first lap joint part and the fourth lap joint part overlapping with the second lap joint part and the third lap joint part respectively.

In the present invention, the connecting section 17 of the second conductive terminal extends from the corresponding weld leg 15 and continuously crosses at least three planes, which can realize the position crossing between the corresponding pin end 14 and the weld leg 15 of the conductive terminal while enhancing the strength of the motor base 100.

Finally, it should be noted that the above embodiments are only used to illustrate the technical solutions of the present invention, rather than to limit them; although the present invention has been described in detail with reference to the above embodiments, ordinary technicians in the field should understand: they can still modify the technical solutions recorded in the above embodiments, or replace some or all of the technical features therein by equivalents; and these modifications or replacements do not make the essence of the corresponding technical solutions deviate from the scope of the technical solutions of the embodiments of the present invention.

The above description is only part of the implementation methods of the present invention, not all implementation methods, any equivalent changes made by ordinary technicians in the field of the present invention by reading the specification of the present invention are covered by the claims of the present invention.

1-29. (canceled)

30. A motor base, comprising:
an insulating base;
a metal circuit disposed on the insulating base; and
an electronic element welded to the metal circuit;
wherein the metal circuit includes a plurality of conductive terminals, the conductive terminals include a first conductive terminal, a second conductive terminal, and a third conductive terminal arranged between the first conductive terminal and the second conductive terminal;
wherein the first conductive terminal includes a bridging part and a first lap joint part extending from the bridging part, the second conductive terminal includes a second lap joint part, the bridging part of the first conductive terminal spans the third conductive terminal, thereby causing the first lap joint part to overlap with the second lap joint part, the insulating base includes a plastic block which is formed by one-shot injection molding and covering the metal circuit and a plastic body formed by two-shot injection molding to at least cover the metal circuit and the plastic block, the first lap joint part and the second lap joint part are positioned by one-shot injection molding of the plastic block so that the first lap joint part and the second lap joint part are fixedly connected to each other.

31. The motor base according to claim 30, wherein the first conductive terminal and the second conductive terminal both include weld legs for welding with the electronic element, and the weld legs of the first conductive terminal and the third conductive terminal and the first lap joint part and the second lap joint part are all positioned by one-shot injection molding of the same plastic block.

32. The motor base according to claim 30, wherein the overlapping position of the second lap joint part and the first lap joint part is defined as the overlapping region, the overlapping region is exposed to the plastic block, the plastic block is provided with concave holes on opposite sides corresponding to the overlapping region, and the overlapping region of the first lap joint part and the second lap joint part correspond to the concave hole exposed on opposite sides of the plastic block respectively.

33. The motor base according to claim 30, wherein only one of the first conductive terminal and the second conductive terminal has a pin end extending out of the insulating base to be electrically connected to an external circuit.

34. The motor base according to claim 31, wherein the second conductive terminal comprises a weld leg for welding with the electronic element and a connecting section extending from the weld leg, the electronic element includes at least two different electronic elements, and the weld legs of the first conductive terminal and the second conductive terminal corresponding to welding the two different electronic elements respectively; a plurality of the plastic blocks are arranged vertically and located on different vertical planes, and the different electronic elements positioned on the different plastic blocks and exposed on the corresponding plastic blocks, the connecting section of the second conductive terminal extends and continuously across at least three planes from the corresponding weld leg, the connecting section spans from the vertical plane where the corresponding weld leg is located to the horizontal plane where the bottom surface of the plastic body is located, and then spans to the vertical plane where the weld leg of the first conductive terminal is located.

35. The motor base according to claim 32, wherein the second lap joint part of the second conductive terminal is fixedly connected to the first lap joint part by soldering method, and at least one of the first lap joint part and the second lap joint part has a hole for accommodating tin material in the overlapping region.

36. The motor base according to claim 35, wherein the first conductive terminal and the second conductive terminal in the overlapping region are surface-coated with gold to form a gold-plated region, the gold-plated region covers the upper surface of the first conductive terminal corresponding to the overlapping area, the lower surface opposite to the upper surface, the inner wall of the hole, and the upper wall of the second conductive terminal relatively close to the lower surface of the first conductive terminal.

37. The motor base according to claim 36, wherein the first lap joint part has the hole in the overlapping region, and the hole is defined as a holding through-hole, the holding through-hole has an opening end away from the second conductive terminal and a resting end near the second conductive terminal, the size of the opening end is smaller than the size of the resting end, and the tin material is contained within the holding through-hole, the second lap joint part has a bulge projecting into the holding through-hole from the upper wall, and the tin material is contained within the holding through-hole and concentrated around the bulge.

38. The motor base according to claim 36, wherein the first lap joint part has the hole in the overlapping region, the hole of the first lap joint part is defined as a holding through-hole, the holding through-hole has an opening end away from the second conductive terminal and a resting end near the second conductive terminal, the second lap joint part has the hole in the overlapping region, the hole of the second lap joint part is defined as a receiving hole, wherein the receiving hole of the second lap joint part is communicated with the holding through-hole in the overlapping region, and the tin material is contained in both the holding through-hole and the receiving hole.

39. The motor base according to claim 38, wherein the size of the opening end is larger than the size of the resting end, and the holding through-hole and the receiving hole are staggered and communicate with each other, the size of the receiving hole near the first lap joint part is smaller than the size of the receiving hole farther from the first lap joint part, and the tin material is contained within both the holding through-hole and the receiving hole.

40. The motor base according to claim 36, wherein the lower surface and the upper wall of the first conductive terminal and the second conductive terminal in the overlapping region have a wave-like concave-convex structure, and the concave-convex structure on the lower surface and the concave-convex structure of the upper wall have different extension directions, the tin material is contained in the hole and the concave-convex structure between the lower surface and the upper wall.

41. The motor base according to claim 35, wherein the second lap joint part has the hole, the hole is defined as a receiving hole, and the first lap joint part in the overlapping region is punched into the receiving hole of the second lap joint part, the first lap joint part is welded and fixed to the second lap joint part.

42. The motor base according to claim 32, wherein the first lap joint part is riveted to the second lap joint part within the overlapping region, the first lap joint part has a protruding portion extending downward, and the second lap joint part has a receiving hole to accommodate the protruding portion in the overlapping region; or the first lap joint part is arranged in parallel and overlapped with the second lap joint part within the overlapping region, and the first lap joint part and the second lap joint part are connected and fixed by resistance welding or laser welding; or, the first lap joint part encapsulates the second lap joint part in the overlapping region, and the first lap joint part is in contact with and connected to the second lap joint part.

43. The motor base according to claim 30, wherein the first conductive terminal comprises a weld leg for welding with the electronic element and a connecting section extending from the weld leg, the bridging part is integrally bent and extended from the connecting section of the first conductive terminal; or the bridging part is arranged separately from the connecting section, and the connecting section of the first conductive terminal further includes a third lap joint part and the bridging part further includes a fourth lap joint part, the third lap joint part overlaps with the fourth lap joint part, and the third lap joint part and the fourth lap joint part are positioned by one-shot injection molding of the plastic block so that the third lap joint part and the fourth lap joint part are fixedly connected to each other.

44. The motor base according to claim 33, wherein the portion of the bridging part not overlapping with the first conductive terminal and the second conductive terminal is at least coated with an insulating layer on the side facing the third conductive terminal, so that the bridging part directly contacts the third conductive terminal, the portion of the bridging part overlapping with the first conductive terminal and the second conductive terminal is exposed on the plastic block, and the portion of the bridging part that is not overlapped with the first conductive terminal and the second conductive terminal is covered by the plastic block.

45. A manufacturing method of a motor base, wherein comprising the following steps:
Step 1: Providing a metal circuit with a plurality of conductive terminals, the conductive terminal includes a first conductive terminal, a second conductive terminal, and a third conductive terminal arranged between the first conductive terminal and the second conductive terminal, the first conductive terminal includes a bridging part and a first lap joint part extending from the bridging part, the second conductive terminal includes a second lap joint part, the bridging part spans across the third conductive terminal, causing the first lap joint part to overlap with the second lap joint part;
Step 2: Defining the overlapping area between the first lap joint part and the second lap joint part as the overlapping region, a plastic block being formed by one-shot injection molding and covering the metal circuit so that the first lap joint part of the first conductive terminal and the second lap joint part of the second conductive terminal are injection molded and positioned by the plastic block, and fixing and connecting the first lap joint part and the second lap joint part within the overlapping region;
Step 3: Positioning the electronic elements on the corresponding weld legs and weld them;
Step 4: Forming a plastic body by two-shot injection molding to at least cover the plastic block and the metal circuit.

46. The manufacturing method of the motor base according to claim 45, wherein before Step 2, a pin fixture is used to position the overlapping region of the first conductive terminal and the second conductive terminal, and after plastic blocks are formed by one-shot injection molding, the pin fixture is removed, and concave holes are formed on opposite sides of the plastic block corresponding to the overlapping regions, the overlapping regions of the first lap joint part and the second lap joint part correspond to the concave holes are exposed on opposite sides of the plastic block respectively.

47. The manufacturing method of the motor base according to claim 45, wherein the fixed connection is achieved by soldering method, the first lap joint part and the second lap joint part are welded with the tin material in the overlapping region at first, and then passed through a reflow oven for welding to complete the fixed connection, the overlapping region and the electronic element located in the same plastic block are simultaneously welded in a reflow furnace; or, the first lap joint part and the second lap joint part are overlapped in parallel, and the fixed connection is made by laser welding to connect the first lap joint part and the second lap joint part; or, the fixed connection is made by riveting, and the first lap joint part has a protruding portion extending downward in the overlapping region, and the second lap joint part has a receiving hole to accommodate the protruding portion.

48. The manufacturing method of the motor base according to claim 47, wherein at least one of the first lap joint part and the second lap joint part has a hole in the overlapping region to receive tin material.

49. The manufacturing method of the motor base according to claim 45, wherein the first conductive terminal comprises a weld leg for welding with the electronic element and a connecting section extending from the weld leg, the bridging part is integrally bent and extended from the connecting section of the first conductive terminal; or the bridging part is arranged separately from the connecting section, and the connecting section of the first conductive terminal further includes a third lap joint part and the bridging part further includes a fourth lap joint part, and in Step 2, the first lap joint part and the fourth lap joint part are simultaneously overlapped to the corresponding second lap joint part and the corresponding third lap joint part, the overlapping areas of the first lap joint part and the second lap joint part, and the third lap joint part and the fourth lap joint part are defined as overlapping region, and the plastic block is formed by one-shot injection molding so that the first lap joint part and the second lap joint part, and the third lap joint part and the fourth lap joint part are injection-molded and positioned by the plastic block, and the first lap joint part and the second lap joint part, and the third lap joint part and the fourth lap joint part are fixedly connected in the overlapping region.
